(19) United States
(12) Patent Application Publication
(10) Pub. No.: US 2023/0099674 A1
(43) Pub. Date: Mar. 30, 2023

(54) VEHICLE BACKUP WARNING SYSTEMS

(71) Applicant: SUBARU CORPORATION, Tokyo (JP)

(72) Inventor: Alex VOIGT, VanBuren Twp, MI (US)

(21) Appl. No.: 17/489,055

(22) Filed: Sep. 29, 2021

(51) Int. Cl. B60T 7/12; G06K 9/46; G06K 9/00; G06T 7/60; B60Q 9/00; B60K 35/00; G08G 1/16

(52) U.S. Cl. CPC B60T 7/12; G06K 9/4661; G06K 9/00805; G06T 7/60; G06K 9/00825; B60Q 9/008; B60K 35/00; G08G 1/166; G06T 2207/30261; B60K 2370/178; B60T 2210/32; B60T 2230/08

(57) ABSTRACT

Aspects of the subject technology relate to a vehicle backup warning system. A rearview image is received from a rearview camera capturing images of an area behind an own vehicle. The rearview image is determined to include a plurality of white pixels each having a luminance value equal to or above a luminance threshold. Two or more white pixels within a first distance of one another are grouped from the plurality of white pixels. The rearview image is determined to include two groups of the two or more white pixels. A distance between centers of the two groups is determined to be equal to or less than a second distance of each other. The two groups are identified as a pair of illuminated backup lights of a vehicle in the area behind the own vehicle. A warning is provided to alert that the vehicle's intention to backup.

### BACKGROUND

### Field

The present disclosure generally relates to vehicle control systems, and more particularly to vehicle backup warning systems.

### Description of the Related Art

Vehicle backup (reverse) lights are used to let other vehicles and pedestrians around a vehicle know that the vehicle is about to move backwards. Vehicle backup lights illuminate in response to a vehicle being shifted to reverse gear. Illuminated vehicle backup lights indicate that the vehicle is about to move backwards or is moving backwards.

The description provided in the background section should not be assumed to be prior art merely because it is mentioned in or associated with the background section. The background section may include information that describes one or more aspects of the subject technology.

### SUMMARY

The disclosed subject matter relates to vehicle backup warning systems.

In accordance with various aspects of the subject disclosure, a computer-implemented method is provided that includes receiving, from a rearview camera capturing one or more images of an area behind an own vehicle, at least a rearview image when the own vehicle is shifted to reverse gear. The rearview image is determined to include a plurality of white pixels each having a luminance value equal to or above a luminance threshold value. Two or more white pixels that are within a first distance of one another are grouped together among the plurality of white pixels each having the luminance value equal to or above the luminance threshold value. The rearview image is determined to include two groups of the two or more white pixels. A distance between centers of the two groups of the two or more white pixels is determined to be equal to or less than a second distance of each other. The two groups of the two or more white pixels are identified as a pair of illuminated backup lights of a vehicle in the area behind the own vehicle. In response to identifying the pair of illuminated backup lights of the vehicle in the area behind the own vehicle, a first warning is provided to the own vehicle that the vehicle in the areas behind the own vehicle intends to backup.

It is understood that other configurations of the subject technology will become readily apparent to those skilled in the art from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 depicts a block diagram of an exemplary backup warning system of a vehicle according to example aspects of the subject technology;

FIG. 2A depicts an exemplary bird-eye-view of vehicles in a parking lot according to example aspects of the subject technology;

FIG. 2B depicts an exemplary rearview image from a backup camera according to example aspects of the subject technology;

FIGS. 3A and 3B show a flowchart illustrating an example process for detecting a backup light of a vehicle in areas behind an own vehicle according to example aspects of the subject technology;

FIGS. 4A and 4B illustrate exemplary rearview images according to example aspects of the subject technology;

FIG. 5 depicts an exemplary visual warning displayed on a monitor according to example aspects of the subject technology;

FIG. 6 shows a flowchart illustrating an example process for warning a driver of an own vehicle about a reversing vehicle according to example aspects of the subject technology;

FIG. 7 shows a flowchart illustrating an example process for controlling an own vehicle according to example aspects of the subject technology; and

FIG. 8 is a block diagram illustrating an example electric system with which the powertrain control system of FIG. 1 can be implemented according to example aspects of the subject technology.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description may include specific details for the purpose of providing a thorough understanding of the subject technology. However, the subject technology is not limited to the specific details set forth herein and may be practiced without these specific details. In some instances, structures and components are shown in block diagram form in order to avoid obscuring the concepts of the subject technology.

Vehicle backup warning systems may include any combination of rear cross-traffic sensors, backup sensors, and backup (rearview) cameras. When an own vehicle equipped with a backup warning system is shifted into reverse, the backup warning system warns the driver of the own vehicle about any objects or vehicles behind the own vehicle to prevent backover accidents when the own vehicle is backing. A backover accident is a type of vehicle accident that occurs when a vehicle moving in reverse comes in contact with another vehicle or an object.

Rear cross-traffic sensors detect vehicles and objects that might cross the path of the own vehicle when backing. For example, in response to detecting a vehicle that might cross the path of own vehicle, a conventional backup warning system warns the driver of the own vehicle that the vehicle that may cross the path of the own vehicle is approaching in order to prevent a backover accident between the own vehicle and the approaching vehicle. Rear cross-traffic sensors, however, may not detect vehicles in areas behind the own vehicle especially when those vehicles are standing still (e.g., parked). Therefore, a conventional backup warning system may not be able to warn the driver of the own vehicle about the vehicles parked in the areas behind the own vehicle.

Backup sensors detect vehicles and objects that are within a certain proximity (e.g., 1.5 meters, 1 meter, 0.75 meters, etc.) of the rear of the own vehicle. Backup sensors typically use proximity sensors, such as ultrasonic proximity sensors or electromagnetic proximity sensors. For example, when another vehicle is detected within the certain proximity of the rear of the own vehicle, a conventional backup warning system warns the driver of the own vehicle that the own vehicle is approaching close to another vehicle behind the own vehicle to prevent a backover accident between the own vehicle and another vehicle.

Backup cameras capture images of areas behind the own vehicle, and the captured images are displayed on a monitor inside the own vehicle providing a comprehensive image of the areas behind the own vehicle. The comprehensive image may include those areas behind the own vehicle that would have be blind spots if the driver of the own vehicle viewed through a rearview mirror or by turning his/her head. The driver of the own vehicle may look at the images of the areas behind the own vehicle displayed on the monitor to determine whether it is safe for the own vehicle to move backwards. When the driver of the own vehicle decides that it is safe for the own vehicle to move backwards based on the images on the monitor, the driver may maneuver the own vehicle to move backwards.

However, even when the rear cross-traffic sensors, the backup sensors, and the backup cameras are used to monitor the areas behind the own vehicle for safety, there are situations in which it is difficult to determine the safety in the areas behind the own vehicle with enough time for the driver of the own vehicle to react to avoid any backover accidents. For example, when the own vehicle and another vehicle behind the own vehicle are both backing toward one another, it is difficult for the driver of the own vehicle to identify, from the images displayed on the monitor, another vehicle behind the own vehicle is backing especially when the own vehicle is simultaneously moving relative to another vehicle moving backwards.

If the resolutions and brightness of the monitor are poor, it is difficult to see the movement of the vehicle or identify the illuminated backup lights of the vehicle from the images displayed on the monitor. Other factors that affect seeing the movement of the vehicle or identify the illuminated backup lights of the vehicle from the images displayed on the monitor may include the poor resolutions of the captured images and the glares on the monitor from the sunlight. The driver of the own vehicle may turn his/her head to check the vehicles and objects behind the own vehicle, but if the vehicle backing towards the own vehicle is in the blind spot and if the driver of the own vehicle cannot determine whether the vehicle behind is backing towards the own vehicle, the driver of the own vehicle may back into the vehicle behind that is backing toward the own vehicle.

Further, since the rear cross-traffic sensors detect vehicles and objects that may cross the path of the own vehicle when backing, another vehicle that is in the path of the own vehicle but does not necessarily cross the path of the own vehicle may not be detected by the rear cross-traffic sensors. Furthermore, since the backup sensors detect only those vehicles and objects that come within the certain proximity of the rear of the own vehicle, the backup sensors detect another vehicle only when another vehicle comes within the certain proximity (e.g., 1.5 meters) of the own vehicle. Thus, by the time when the backup sensors detect another vehicle, the driver of the own vehicle may not have enough time to react to avoid colliding with another vehicle especially when both the own vehicle and another vehicle are moving towards each other.

To address the above problems, the subject technology provides technical solutions of providing systems and methods for detecting backup lights using images captured by backup cameras. The disclosed techniques provide for reducing the risk of backover accidents.

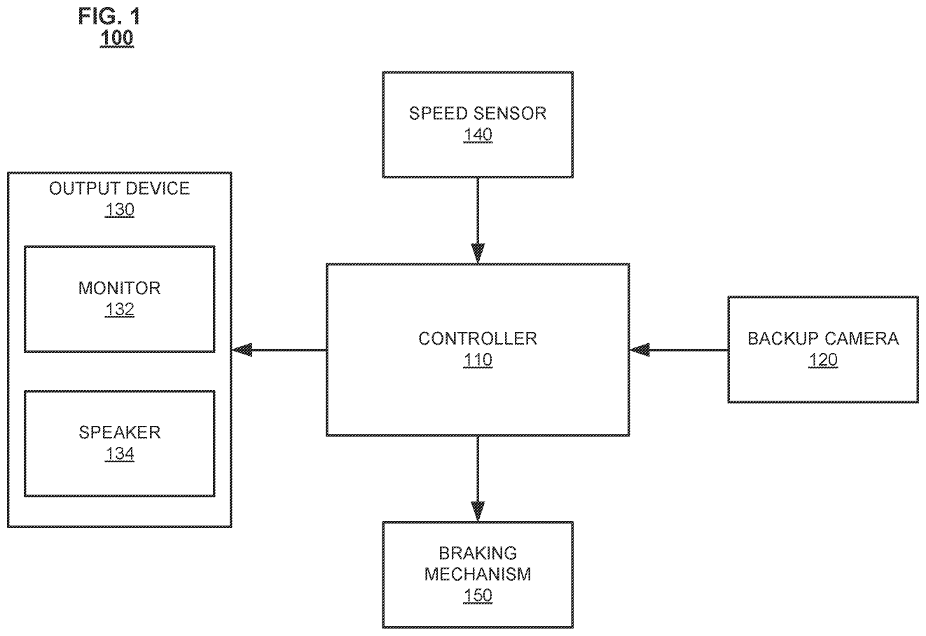

FIG. 1 depicts a block diagram of an exemplary backup warning system 100 of an own vehicle according to example aspects of the subject technology. As shown in FIG. 1, backup warning system 100 includes a controller 110, a backup camera 120, an output device 130, a speed sensor 140, and a braking mechanism 150.

Controller 110 may represent various forms of processing devices having at least a processor, at least a memory, and communication capability. Controller 110 may communicate with backup camera 120, output device 130, speed sensor 140, and braking mechanism 150. For example, controller 110 receives image data from backup camera 120, analyzes the received image data, and controls output device 130 based on the analysis results. In some embodiments, controller 110 may further receive speed data from speed sensor 140 and controls braking mechanism 150 based on the analysis result and the received speed data.

Backup camera 120 is mounted on the own vehicle and captures one or more images of areas behind the own vehicle and transmits the captured one or more images of the areas behind the own vehicle to controller 110. For example, backup camera 120 is mounted on the rear part of the own vehicle. In some embodiments, backup camera 120 may be mounted on other parts of the own vehicle as long as backup camera 120 can capture the areas behind the own vehicle. Backup camera 120 may begin capturing the images in response to the own vehicle being shifted to reverse. The number of backup camera 120 is not limited to one as depicted in FIG. 1, but the number of backup camera 120 may be one or more.

Output device 130 includes a monitor 132 and a speaker 134 which are arranged inside the vehicle. Controller 110 may control monitor 132 to display a visual warning to warn the driver of the own vehicle about another vehicle in the areas behind the own vehicle, and control speaker 134 to output an audio warning to warn the driver of the own vehicle about another vehicle in the areas behind the own vehicle.

Monitor 132 may be arranged, for example, on a center console of the own vehicle, an instrumental panel of the vehicle, or a steering wheel of the own vehicle. Monitor 132 may be arranged in other sections of a dashboard of the vehicle as long as the driver of the own vehicle can view the content of monitor 132 from the driver's seat. The number of monitor 132 is not limited to one as depicted in FIG. 1, but the number of monitor 132 may be one or more. For instance, one monitor may be arranged on the center console, and another monitor may be arranged on the instrumental panel. In another instance, two monitors may be arranged adjacent one another on the center console.

Speaker 134 may be arranged anywhere inside the own vehicle as long as the sound from the speaker is audible to the driver of the vehicle. The number of speaker 134 is not limited to one as depicted in FIG. 1, but the number of speaker 134 may be one or more.

Speed sensor 140 detects a speed of the own vehicle and transmits the speed data of the own vehicle to controller 110. Braking mechanism 150 may use, for example, a friction braking method that uses friction braking force to stop the vehicle. According to the speed data of the own vehicle received from speed sensor 140, controller 110 controls braking mechanism 150 to stop the vehicle.

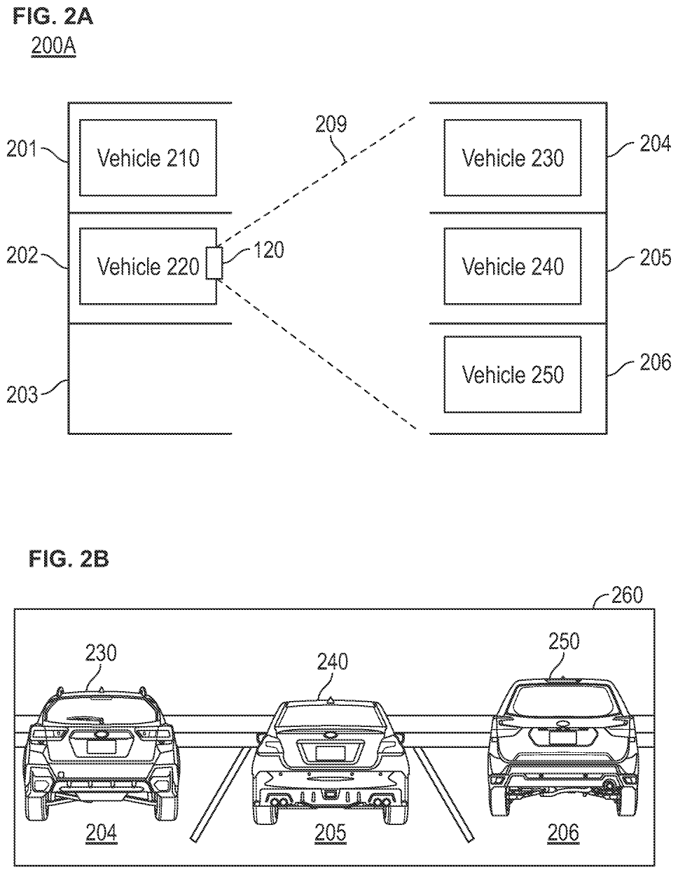

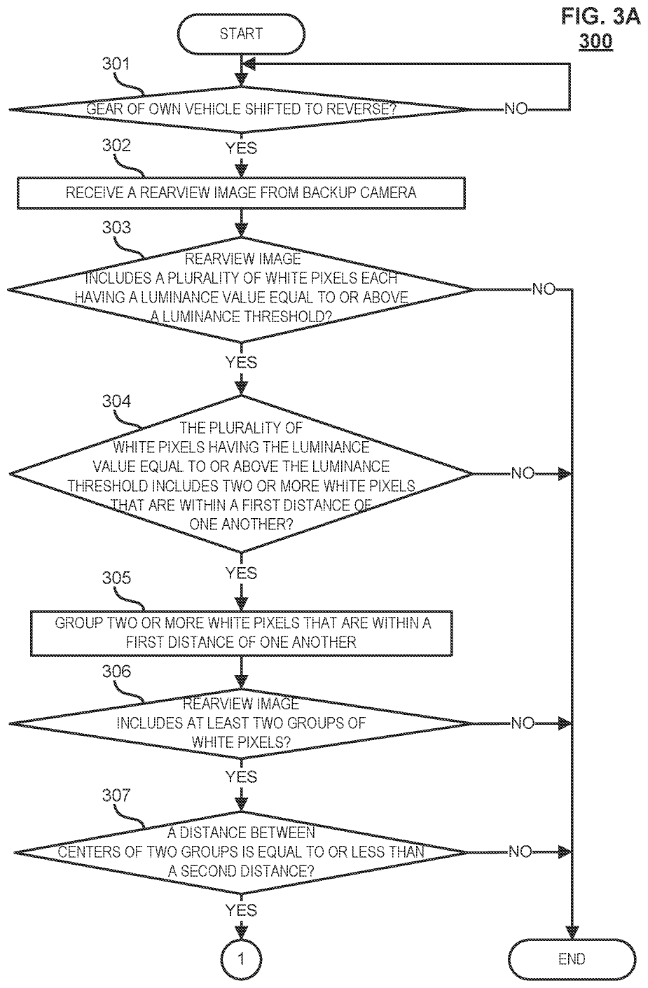

Referring to FIG. 2A that illustrates a bird-eye-view of a parking lot 200A. Parking lot 200A includes parking spaces 201-206. A vehicle 210 is parked in parking space 201; a vehicle 220 is parked in parking space 202; a vehicle 230 is parked in parking space 204; a vehicle 240 is parked in parking space 205; and a vehicle 250 is parked in parking space 206. No vehicle is parked in parking space 203. Vehicles 210-250 may be forward parked such that vehicles 210-250 have pulled forward first into respective parking spaces 201, 202, and 204-206.

For example, backup camera 120 may be mounted on the rear part of vehicle 220 (i.e., own vehicle) in parking space 202. As shown in FIG. 2A, backup camera 120 may have a field of view 209 represented by two dotted lines extending from backup camera 120 mounted on the rear part of vehicle 220 towards vehicles 230-250. For example, in response to vehicle 220 being shifted to reverse, backup camera 120 starts capturing one or more images of areas behind vehicle 220.

FIG. 2B illustrates a rearview image 260 captured by backup camera 120. Rearview image 260 includes vehicles 230-250 parked in parking spaces 204-206, respectively. As depicted in FIG. 2B, vehicles 230-250 are parked forward first into respective parking spaces 204-206. Rearview image 260 is transmitted from backup camera 120 to controller 110 for analysis.

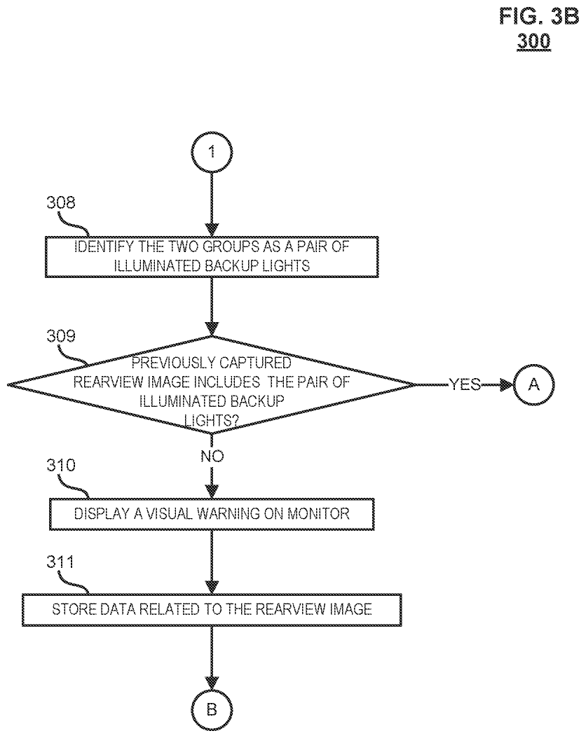

FIGS. 3A and 3B show a flowchart illustrating an example process 300 for detecting a backup light of a vehicle in areas behind an own vehicle according to example aspects of the subject technology. For explanatory purposes, the various blocks of example process 300 are described herein with reference to the components and/or processes described herein. The one or more of the blocks of process 300 may be implemented, for example, by one or more components or processors of controller 110 of FIG. 1. In some implementations, one or more of the blocks may be implemented apart from other blocks, and by one or more different processors or controllers. Further, for explanatory purposes, the blocks of example process 300 are described as occurring in serial, or linearly. However, multiple blocks of example process 300 may occur in parallel. In addition, the blocks of example process 300 need not be performed in the order shown and/or one or more of the blocks of example process 300 need not be performed.

At block 301 of FIG. 3A, controller 110 determines whether the gear of the own vehicle is shifted to reverse gear. For example, when the driver of vehicle 220 shifts to the reverse gear, controller 110 determines that the gear of the own vehicle is shifted to reverse gear. When controller 110 determines that the gear of the own vehicle is not shifted to the reverse gear (block 301=NO), process 300 returns to block 301. When controller determines that the gear is shifted to the reverse gear (block 301=YES), process 300 proceeds to block 302.

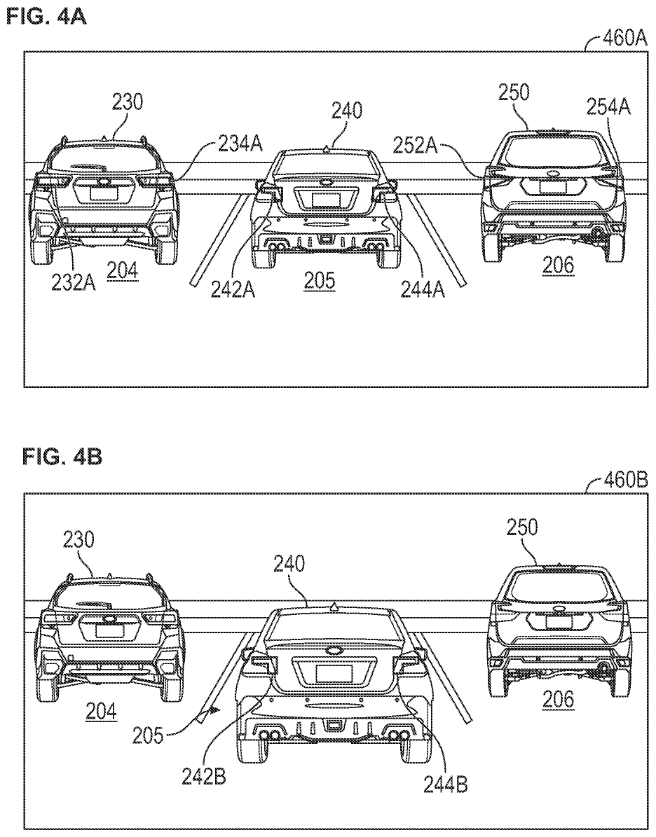

At block 302, controller 110 receives a rearview image from backup camera 120 mounted on vehicle 220. For example, in response to determining that the gear of the own vehicle is shifted to the reverse gear, controller 110 may receive a rearview image 460A depicted in FIG. 4A from backup camera 120. Similar to rearview image 260 in FIG. 2B, rearview image 460A includes vehicles 230-250 that are parked in parking spaces 204-206, respectively.

At block 303, controller 110 determines whether rearview image 460A includes a plurality of white pixels each having a luminance value equal to or above a luminance threshold. For example, controller 110 may identify pixels in regions 232A, 234A, 242A, 244A, 252A, and 254A in rearview image 460A as white pixels each having a luminance value equal or above the luminance threshold. The luminance threshold may be determined based on sample test data on illuminated backup lights of vehicles. Thus, regions 232A, 234A, 242A, 244A, 252A, and 254A in rearview image 460A may represent backup lights. For example, regions 232A and 234A may represent the backup lights of vehicle 230, regions 242A and 244A may represent with the backup light of vehicle 240, and regions 252A and 254A may represent with backup lights of vehicle 250. In other words, for example, if the pixels in regions 242A and 244A in rearview image 360A are determined to have the luminance value equal to or above the luminance threshold, the backup light of vehicle 240 represented in regions 242A and 244A may be considered to be illuminating.

When controller 110 identifies, within rearview image 460A, none or only one white pixel representing the color white and having the luminance value equal to or above the luminance threshold, controller 110 determines that rearview image 460A does not include any white pixels each having a luminance value equal to or above a luminance threshold (block 303=NO), and process 300 ends. When controller 110 identifies, within rearview image 460A, a plurality of pixels (i.e., two or more pixels) representing the color white and having the luminance value equal to or above the luminance threshold, controller 110 determines that rearview image 460A includes a plurality of white pixels each having a luminance value equal to or above a luminance threshold (block 303=YES), and process 300 proceeds to block 304.

At block 304, controller 110 determines whether the plurality of white pixels each having a luminance value equal to or above a luminance threshold includes two or more pixels that are within a first distance (e.g., adjacent one another) of one another. When the plurality of white pixels does not include two or more pixels that are within the first distance of one another (block 304=NO), process 300 ends. When the plurality of white pixels includes two or more pixels that are within the first distance of one another (block 304=YES), process 300 proceeds to block 305.

At block 305, the two or more white pixels that are within the first distance of one another are grouped. Controller 110 may identify, amongst the pixels representing the color white and having the luminance value equal to or above the luminance threshold, two or more white pixels that are within a certain distance (e.g., adjacent one another) of one another, and group those identified two or more white pixels together into a group. For example, controller 110 identifies the pixels in regions 242A and 244A to be white pixels having the luminance value equal to or above the luminance threshold, and further identifies those pixels in region 242A to be adjacent one another and those pixels in region 244A to be adjacent one another. Controller 110 groups those pixels in regions 242A into one group and those pixels in regions 244A into another group. Process 300 then proceeds to block 306.

At block 306, controller 110 determines whether rearview image 460A includes at least two groups of white pixels having luminance value equal to or above the luminance threshold and being adjacent one another. Controller 110 may refer to one or more groups of white pixels formed at block 305. For example, at block 305, controller 110 formed a first group of white pixels (i.e., pixels in region 242A) and a second group of white pixels (i.e., pixels in region 244A), and controller 110 may refer to the first group and the second group to determine whether rearview image 460A includes at least two groups of white pixels. When none or only one group is formed at block 305 (block 306=NO), process 300 ends. When two or more groups are formed at block 305 (block 306=YES), process 300 proceeds to block 307.

At block 307, controller 110 determines whether a distance between centers of any two groups of white pixels is equal to or less than a second distance. For example, controller 110 measures a distance between the center of the first group (i.e., pixels in region 242A) and the center of the second group of white pixels (i.e., pixels in region 244A), and compares the measured distance to the second distance (e.g., 20 pixels, 30 pixels). The first distance can be set by considering, for example, a resolution of an image, a distance between two vehicles, a regulation of a position of backup lights, and so forth. When the distance between the centers of two groups is more than the second distance (block 307=NO), process 300 ends. When the distance between the centers of two groups of white pixels is equal to or less than the second distance (block 307=YES), process 300 proceeds to block 1 in FIG. 3B.

Moving to block 1 in FIG. 3B, process 300 proceeds to block 308 in which controller 110 identifies the two groups of white pixels determined to be separated by a distance equal to or less than the second distance at block 307 as a pair of illuminated backup lights of a vehicle. For example, controller 110 identifies the first group (i.e., pixels in region 242A) and the second group of white pixels (i.e., pixels in region 244A) as the pair of backup lights of vehicle 240 that are illuminating. Process 300 proceeds to block 309.

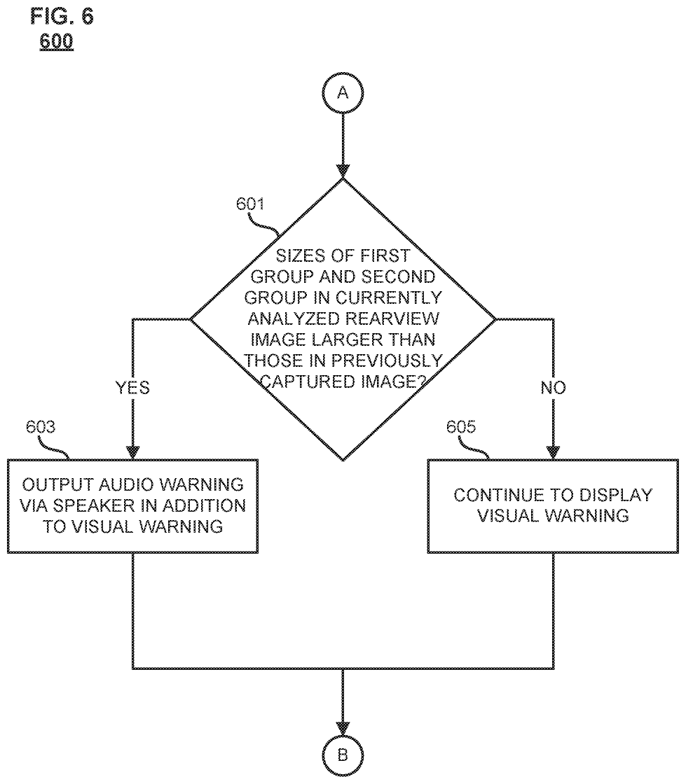

At block 309, controller 110 determines whether a previously captured rearview image includes the pair of illuminated backup lights. Controller 110 may determine whether data related to a previously captured rearview image is stored in the memory of controller 110. A previously captured rearview image may be, for example, a rearview image captured one frame prior to the rearview image currently being analyzed by controller 110. When controller 110 determines that data related to the previously captured rearview image is stored in the memory of controller 110, controller 110 determines whether the previously captured rearview image includes the pair of illuminated backup lights (i.e., backup lights of vehicle 240). When controller 110 determines that the previously captured rearview image includes the pair of illuminated backup lights (block 309=YES), process 300 proceeds to block A in FIG. 6. When controller 110 determines that the previously captured rearview image does not include the pair of illuminated backup lights (block 309=NO), process 300 proceeds to block 310.

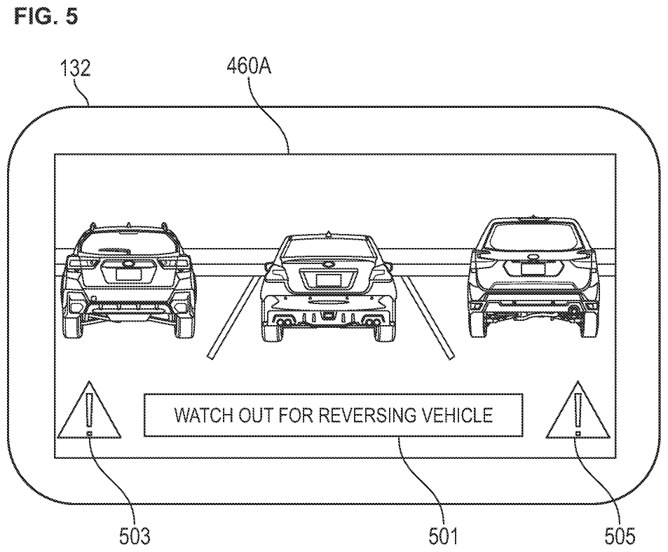

At block 310, controller 110 controls monitor 132 of output device 130 to display a visual warning to alert the driver of vehicle 220 that vehicle 240 is reversing. Controller 110 may control monitor 132 to display a visual warning along with a rearview image (i.e., rearview image 460A) currently being analyzed by controller 110 as depicted in FIG. 5. A visual warning being displayed on monitor 132 may include a text warning, for example, “WATCH OUT FOR REVERSING VEHICLE”. In some embodiments, a visual warning may further includes one or more exclamation marks. The visual warning may be flashing to drawn attention of the driver of vehicle 220.

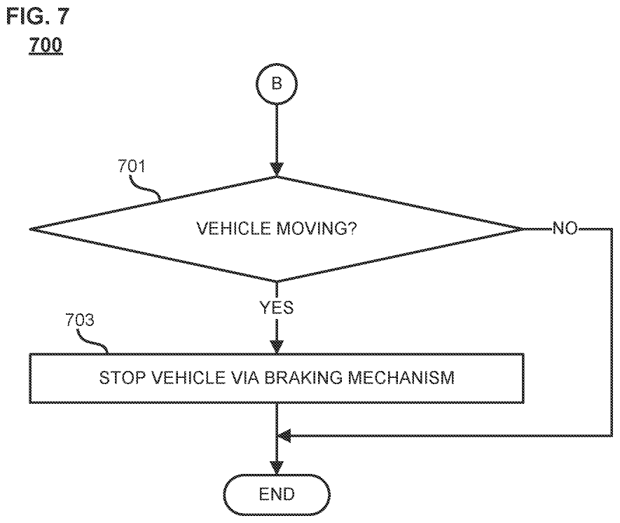

At block 311, controller 110 stores, in the memory of controller 110, data related to the rearview image that is currently being analyzed by controller 110. In some embodiments, the data related to the rearview images may be removed from the memory when vehicle 220 shifts to another gear from reverse gear. Process 300 proceeds to block B in FIG. 7. In some embodiments, process 300 may end at block 311 without proceeding to block B. Blocks 301-311 may be performed for every image captured by backup camera 120 while vehicle 220 is in the reverse gear.

FIG. 6 shows a flowchart illustrating an example process 600 for warning the driver of vehicle 220 about a reversing vehicle according to example aspects of the subject technology. For explanatory purposes, the various blocks of example process 600 are described herein with reference to the components and/or processes described herein. The one or more of the blocks of process 600 may be implemented, for example, by one or more components or processors of controller 110 of FIG. 1. In some implementations, one or more of the blocks may be implemented apart from other blocks, and by one or more different processors or controllers. Further, for explanatory purposes, the blocks of example process 600 are described as occurring in serial, or linearly. However, multiple blocks of example process 600 may occur in parallel. In addition, the blocks of example process 600 need not be performed in the order shown and/or one or more of the blocks of example process 600 need not be performed.

When controller 110 determines that a previously captured rearview image includes the pair of illuminated backup lights at block 309 of process 300 in FIG. 3B, process 300 proceeds to block A in process 600 in FIG. 6. Referring to rearview images 460A in FIG. 4A and 460B in FIG. 4B, rearview image 460A depicts an image captured one frame prior to rearview image 460B. Thus, when controller 110 analyzes rearview image 460B using process 300, controller 110 determines that a previously captured rearview image (i.e., rearview image 460A) includes the pair of illuminated backup lights at block 309, proceeding to block A in process 600 in FIG. 6.

Block A then proceeds to block 601 in which controller 110 determines whether sizes of the first group of white pixels and the second group of white pixels, which are identified as the pair of illuminated backup lights, in the rearview image currently being analyzed (i.e., rearview image 460B) are larger than sizes of the first group of white pixels and the second group of white pixels of the previously captured rearview image (i.e., rearview image 460A).

For example, controller 110 measures a size of the first group of white pixels (i.e., a group of pixels in a region 242B) and a size of the second group of white pixels (i.e., a group of pixels in a region 244B) in rearview image 460B. Controller 110 may compare the sizes of the first group and the second group in rearview image 460B to those in the previously captured rearview image (i.e., rearview image 460A). As depicted in FIGS. 4A and 4B, vehicle 240 can be seen fully pulled into parking space 205 in rearview image 460A, and vehicle 240 can be seen a half way pulled out of parking space 205 in rearview image 460B. The change in the position of vehicle 240 relative to parking space 205 indicates that vehicle 240 is backing out of parking space 205. Since vehicle 240 is approaching vehicle 220 on which backup camera 120 is mounted, the sizes of first group and the second group in rearview image 460B are larger than those in rearview image 460A as depicted in FIGS. 4A and 4B.

When controller 110 determines that the sizes of the first group and the second group in the rearview image currently being analyzed are larger than those in the previously captured rearview image (block 601=YES), process 600 proceeds to block 603. When controller 110 determines that the sizes of the first group and the second group in the rearview image currently being analyzed are equal to or smaller than those in the previously captured rearview image (block 601=NO), process 600 proceeds to block 605.

When the first group and the second group in the rearview image currently being analyzed have more pixels than those in the previously captured rearview image, it may be possible to determine that the sizes of the first group and the second group in the rearview image currently being analyzed are larger than those in the previously captured rearview image.

At block 603, controller 110 controls speaker 134 of output device 130 to output audio warning in addition to the visual warning being displayed on monitor 132 to further alert the driver of the own vehicle (i.e., vehicle 220) about a vehicle (i.e., vehicle 240) behind backing from the parking space (i.e., parking space 205). Increase in the sizes of the first group and the second group in the currently analyzed rearview image (i.e., rearview image 460B) indicates that the vehicle (i.e., vehicle 240) behind is approaching the own vehicle (i.e., vehicle 220). Thus, controller 110 adds the audio warning to the already-displayed visual warning to draw additional attention of the driver of the own vehicle. Process 600 then proceeds to block B of process 700 in FIG. 7.

At block 605, controller 110 continues to control monitor 132 to display the visual warning. Since the backup lights of the vehicle (i.e., vehicle 240) behind are illuminated, the vehicle behind may back towards the own vehicle (i.e., vehicle 220). However, the sizes of the first group and the second group in the currently analyzed rearview image (i.e., rearview image 460B) have not increased when compared to the sizes of the first group and the second group in the previously captured rearview image (i.e., rearview image 460A). Thus, the vehicle (i.e., vehicle 240) is not yet approaching the own vehicle (i.e., vehicle 220). Process 600 then proceeds to block B of process 700 in FIG. 7.

FIG. 7 shows a flowchart illustrating an example process 700 for controlling the own vehicle (i.e., vehicle 220) according to example aspects of the subject technology. For explanatory purposes, the various blocks of example process 700 are described herein with reference to the components and/or processes described herein. The one or more of the blocks of process 700 may be implemented, for example, by one or more components or processors of controller 110 of FIG. 1. In some implementations, one or more of the blocks may be implemented apart from other blocks, and by one or more different processors or controllers. Further, for explanatory purposes, the blocks of example process 700 are described as occurring in serial, or linearly. However, multiple blocks of example process 700 may occur in parallel. In addition, the blocks of example process 700 need not be performed in the order shown and/or one or more of the blocks of example process 700 need not be performed.

At block 701, controller 110 determines whether the own vehicle (i.e., vehicle 220) is moving. For example, controller 110 may refer to data from speed sensor 140 to determine whether the own vehicle (i.e., vehicle 220) is backing. When the data from speed sensor 140 indicates that the own vehicle is not moving (i.e., standing still) (block 701=NO), process 700 ends. When the data from speed sensor 140 indicates that the own vehicle is moving (i.e., backing from parking space 202) (block 701=YES), process 700 proceeds to block 703.

At block 703, controller 110 controls braking mechanism 150 to stop the own vehicle (i.e., vehicle 220). For example, braking mechanism 150 may apply friction braking force to stop the movement of the own vehicle to avoid a backover accident between the own vehicle (i.e., vehicle 220) and the backing vehicle (i.e., vehicle 240) behind the own vehicle.

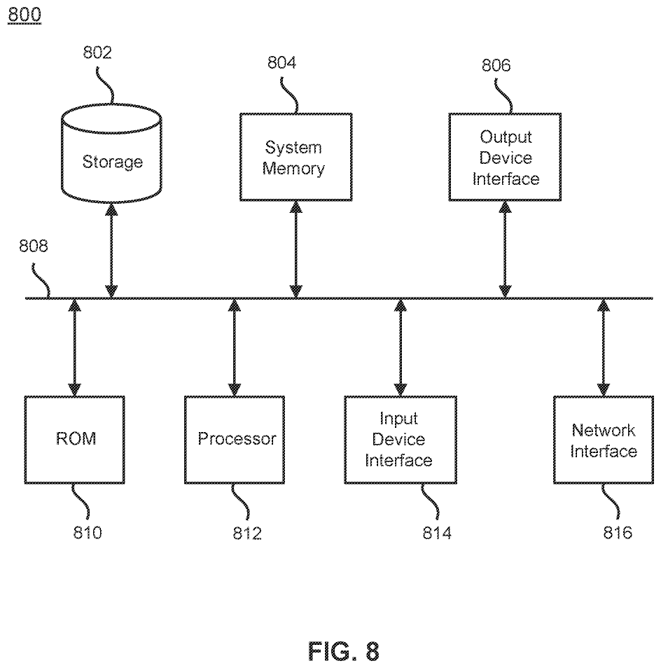

FIG. 8 is a block diagram illustrating an exemplary electronic system 800 with which controller 110 of FIG. 1 can be implemented to control the vehicle. In certain aspects, the electronic system 800 may be implemented using hardware or a combination of software and hardware, either in a dedicated electronic control unit (ECU), or integrated into another entity, or distributed across multiple entities. Electronic system 800 (e.g., controller 110) includes a bus 808, a processor 812, a system memory 804, a read-only memory (ROM) 810, a permanent storage device 802, an input device interface 814, an output device interface 806, and a network interface 816.

Bus 808 collectively represents all system, peripheral, and chipset buses that communicatively connect the numerous internal devices of electronic system 800. For instance, bus 808 communicatively connects processor 812 with ROM 810, system memory 804, and permanent storage device 802.

From these various memory units, processor 812 retrieves instructions to execute and data to process in order to execute the processes of the subject disclosure. The processor 812 can be a single processor or a multi-core processor in different implementations.

ROM 810 stores static data and instructions that are needed by processor 812 and other modules of the electronic system. Permanent storage device 802, on the other hand, is a read-and-write memory device. This device is a non-volatile memory unit that stores instructions and data even when electronic system 800 is off. Some implementations of the subject disclosure use a mass-storage device (for example, a magnetic or optical disk, or flash memory) as permanent storage device 802.

Other implementations use a removable storage device (for example, a flash drive) as permanent storage device 802. Like permanent storage device 802, system memory 804 is a read-and-write memory device. However, unlike storage device 802, system memory 804 is a volatile read-and-write memory, such as a random access memory. System memory 804 stores some of the instructions and data that the processor needs at runtime. In some implementations, the processes of the subject disclosure are stored in system memory 804, permanent storage device 802, or ROM 810. For example, the various memory units include instructions for displaying graphical elements and identifiers associated with respective applications, receiving a predetermined user input to display visual representations of shortcuts associated with respective applications, and displaying the visual representations of shortcuts. From these various memory units, processor 812 retrieves instructions to execute and data to process in order to execute the processes of some implementations.

Bus 808 also connects to input and output device interfaces 814 and 806. Input device interface 814 enables the user to communicate information and select commands to the electronic system. Input devices used with input device interface 814 include, for example, alphanumeric keyboards and pointing devices (also called “cursor control devices”). Output device interfaces 806 enables, for example, the display of images generated by the electronic system 800 (e.g., accelerator pedal maps). Output devices used with output device interface 806 include, for example, display devices, for example, cathode ray tubes (CRT) or liquid crystal displays (LCD). Some implementations include devices, for example, a touchscreen that functions as both input and output devices.

Finally, as shown in FIG. 8, bus 808 also couples electronic system 800 to a network (not shown) through a network interface 816. In this manner, the computer can be a part of a network of computers (for example, a CAN, a LAN, a WAN, or an Intranet, or a network of networks, for example, the Internet). Any or all components of electronic system 800 can be used in conjunction with the subject disclosure.

Many of the above-described features and applications are implemented as software processes that are specified as a set of instructions recorded on a computer readable storage medium (also referred to as computer readable medium). When these instructions are executed by one or more processors (e.g., one or more processors, cores of processors, or other processing units), they cause the processors to perform the actions indicated in the instructions. Examples of computer readable media include, but are not limited to, magnetic media, optical media, electronic media, etc. The computer readable media does not include carrier waves and electronic signals passing wirelessly or over wired connections.

In this specification, the term “software” is meant to include, for example, firmware residing in read-only memory or other form of electronic storage, or applications that may be stored in magnetic storage, optical, solid state, etc., which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage, and memory that store computer program instructions in a machine-readable or computer-readable medium (alternatively referred to as computer-readable storage media, machine-readable media, or machine-readable storage media). Such electronic components are implemented by circuitry including, for example, one or more semiconductor integrated circuits. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself. ASICs and FPGAs are also implemented by semiconductor integrated circuits.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It may be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor may they be interpreted in such a way.

What is claimed is:

1. A computer-implemented method for detecting a reverse light, the computer-implemented method comprising:
receiving, from a rearview camera capturing one or more images of an area behind an own vehicle, at least a rearview image when the own vehicle is shifted to reverse gear;
determining that the rearview image includes a plurality of white pixels each having a luminance value equal to or above a luminance threshold value;
grouping, among the plurality of white pixels each having the luminance value equal to or above the luminance threshold value, two or more white pixels that are within a first distance of one another;
determining that the rearview image includes two groups of the two or more white pixels;
determining that a distance between centers of the two groups of the two or more white pixels is equal to or less than a second distance of each other;
identifying the two groups of the two or more white pixels as a pair of illuminated backup lights of a vehicle in the area behind the own vehicle; and
in response to identifying the pair of illuminated backup lights of the vehicle in the area behind the own vehicle, providing, to the own vehicle, a first warning indicating that the vehicle in the areas behind the own vehicle intends to backup.

2. The computer-implemented method of claim 1, further comprising determining that a previous rearview image captured one frame prior to the rearview image includes the pair of illuminated backup lights.

3. The computer-implemented method of claim 2, further comprising determining that sizes of the two groups associated with the pair of illuminated backup lights in the rearview image are larger than sizes of two groups of white pixels associated with the pair of illuminated backup lights in the previous rearview image.

4. The computer-implemented method of claim 3, further comprising, in response to determining that the sizes of the two groups associated with the pair of illuminated backup lights in the rearview image are larger than the sizes of the two groups of white pixels associated with the pair of illuminated backup lights in the previous rearview image, providing, to the own vehicle, a second warning indicating that the vehicle in the areas behind the own vehicle is backing towards the own vehicle.

5. The computer-implemented method of claim 4,
wherein the first warning includes a visual warning displayed on a monitor inside the own vehicle, and
wherein the second warning includes an audio warning output from at least a speaker inside the own vehicle.

6. The computer-implemented method of claim 1, further comprising:
determining, in response to identifying the pair of illuminated backup lights of the vehicle in the area behind the own vehicle, that the own vehicle is moving based on speed data from a speed sensor; and
stopping, in response to determining that the own vehicle is moving, the own vehicle using a braking mechanism of the own vehicle.

7. The computer-implemented method of claim 3, further comprising:
determining, in response to determining that the sizes of the two groups associated with the pair of illuminated backup lights in the rearview image are larger than the sizes of the two groups of white pixels associated with the pair of illuminated backup lights in the previous rearview image, that the own vehicle is moving based on speed data from a speed sensor; and
stopping, in response to determining that the own vehicle is moving, the own vehicle using a braking mechanism of the own vehicle.

8. A system comprising:
a rearview camera capturing one or more images of an area behind an own vehicle; and
circuitry that perform operations comprising:
receiving, from a rearview camera capturing one or more images of an area behind an own vehicle, at least a rearview image when the own vehicle is shifted to reverse gear;
determining that the rearview image includes a plurality of white pixels each having a luminance value equal to or above a luminance threshold value;
grouping, among the plurality of white pixels each having the luminance value equal to or above the luminance threshold value, two or more white pixels that are within a first distance of one another;
determining that the rearview image includes two groups of the two or more white pixels;
determining that a distance between centers of the two groups of the two or more white pixels is equal to or less than a second distance of each other;
identifying the two groups of the two or more white pixels as a pair of illuminated backup lights of a vehicle in the area behind the own vehicle; and
in response to identifying the pair of illuminated backup lights of the vehicle in the area behind the own vehicle, providing, to the own vehicle, a first warning indicating that the vehicle in the areas behind the own vehicle intends to backup.

9. The system of claim 8, wherein the operations further comprising determining that a previous rearview image captured one frame prior to the rearview image includes the pair of illuminated backup lights.

10. The system of claim 9, wherein the operations further comprising determining that sizes of the two groups associated with the pair of illuminated backup lights in the rearview image are larger than sizes of two groups of white pixels associated with the pair of illuminated backup lights in the previous rearview image.

11. The system of claim 10, wherein the operations further comprising, in response to determining that the sizes of the two groups associated with the pair of illuminated backup lights in the rearview image are larger than the sizes of the two groups of white pixels associated with the pair of illuminated backup lights in the previous rearview image, providing, to the own vehicle, a second warning indicating that the vehicle in the areas behind the own vehicle is backing towards the own vehicle.

12. The system of claim 11,
wherein the first warning includes a visual warning displayed on a monitor inside the own vehicle, and
wherein the second warning includes an audio warning output from at least a speaker inside the own vehicle.

13. The system of claim 8, wherein the operations further comprising:
determining, in response to identifying the pair of illuminated backup lights of the vehicle in the area behind the own vehicle, that the own vehicle is moving based on speed data from a speed sensor; and
stopping, in response to determining that the own vehicle is moving, the own vehicle using a braking mechanism of the own vehicle.

14. The system of claim 10, wherein the operations further comprising:
determining, in response to determining that the sizes of the two groups associated with the pair of illuminated backup lights in the rearview image are larger than the sizes of the two groups of white pixels associated with the pair of illuminated backup lights in the previous rearview image, that the own vehicle is moving based on speed data from a speed sensor; and
stopping, in response to determining that the own vehicle is moving, the own vehicle using a braking mechanism of the own vehicle.
